(19) United States
(12) Patent Application Publication
(10) Pub. No.: US 2010/0242668 A1
(43) Pub. Date: Sep. 30, 2010

(54) BICYCLE WITH A BEARING

(76) Inventor: Thomas GÖRING, Karlsruhe (DE)

Correspondence Address: MCGLEW & TUTTLE, PC, P.O. BOX 9227, SCARBOROUGH STATION, SCARBOROUGH, NY, 10510-9227, US

(21) Appl. No.: 12/723,786

(22) Filed: Mar. 15, 2010

(30) Foreign Application Priority Data
Mar. 25, 2009 (DE) 20 2009 004 546.3
May 5, 2009 (DE) 10 2009 020 764.3
Feb. 25, 2010 (DE) 10 2010 010 367.5

(51) Int. Cl. B62M 3/00; B62M 1/02

(52) U.S. Cl. 74/594.1; 280/260

(57) ABSTRACT

A bicycle (1) with a bearing (126) including at least one plain bearing bush (126a). The at least one plain bearing bush (126a,) is provided to absorb the radially acting forces. At least one rolling element bearing is provided to absorb the axially acting forces.

### CROSS REFERENCE TO RELATED APPLICATIONS

This application claims the benefit of priority under 35 U.S.C. §119 of German Patent Applications DE 20 2009 004 546.3 filed Mar. 25, 2009, DE 10 2009 020 764.3 filed May 5, 2009 and DE 10 2010 010 367.5 filed Feb. 25, 2010 the entire contents of each of which are incorporated herein by reference.

### FIELD OF THE INVENTION

The invention relates to a bicycle with a bicycle hub with an axle axis which defines an axial direction, a hollow hub body which is mounted rotatably on the axle and at least one lock nut which secures the hub body in the axial direction. The invention further relates to a bicycle with a frame with a bottom bracket shell and a bottom bracket spindle with pedal crank arms, carrying pedals, mounted by means of a bottom bracket in the bottom bracket shell.

### BACKGROUND OF THE INVENTION

It is conventional for the bottom bracket of a bicycle to comprise ball bearings for bearing the crank shaft. Thus, the crank shaft can rotate substantially without friction, i.e. pedaling is not rendered difficult by friction. Because the bottom bracket shell has a inner diameter that is larger than the outer diameter of the crank shaft plus the size of the ball bearings, a cap or another adapter made of steel may be screwed into the bottom bracket shell to reduce the inner diameter.

The US 2008/0200290 A1 discloses a bicycle hub of this kind. The hub body is mounted on the axle by means of ball bearings, which absorb radial forces. Moreover, it is known to use a cone as a lock nut, which presses against an obliquely arranged ball bearing, so that both axial and radial forces can be absorbed.

A bicycle is known from the DE 10 2009 005 918 A1 published later, in which a bottom bracket spindle with pedals is mounted in a bottom bracket shell by means of a bottom bracket, wherein the bottom bracket and/or the control bearing comprises at least one plain bearing bush acting in the radial direction.

### SUMMARY OF THE INVENTION

One aspect of the present invention is the provision of improvements to a bicycle of the type described above.

The bicycle comprises a bottom bracket, wherein the bottom bracket comprises at least one plain bearing bush provided for absorbing the radially acting forces, which is arranged and mounted radially between the bottom bracket spindle and the bottom bracket shell, and in the bottom bracket at least one axial bearing for absorbing the axially acting forces is provided, which is arranged axially on the outside of the bottom bracket and leans on a tread.

A spatial separation preferably takes place, i.e. the plain bearing bush absorbs—at least in a cylinder-shaped sub-area—only radially effective forces, and the axial bearing only absorbs axially effective forces.

The acting forces are absorbed and forwarded by the two bearings, i.e. by the radial bearing and by the axial bearing. In doing so, the radial forces are absorbed by the plain bearing bush, whereas the axially effective forces are absorbed by the axial bearing, preferably each exclusively. The axial bearing is preferably a roller bearing, especially a ball bearing, i.e. the friction of this bearing is, in normal uses, less than that of the radial bearing, particularly preferred almost negligibly small. Alternatively, a plain bearing is also conceivable, wherein also in this case the friction is preferably such that it is less than that of the radial bearing.

The plain bearing bush for the radial mounting is cheaper than a conventional ball bearing. As the plain bearing bush is a “friction bearing”, friction occurs. This friction, for example, makes it easier to perform tricks with a BMX freestyle bicycle. The plain bearing bush can be formed in the simplest case in one piece with an edge projecting in the radial direction. This edge—if the axial bearing is a plain bearing—can form the axial bearing. Of course, a bipartite arrangement of the radial and axial bearing is also possible, wherein the axial bearing is preferably a ball bearing.

The plain bearing preferably has a coefficient of static friction amounting to a minimum of 0.08, particularly a minimum of 0.1 and particularly preferably a minimum of 0.15. The higher the static friction, the more safely, for example, is a pedal position maintained during a trick performed with a BMX bike, during which the foot leaves the pedal, thus increasing also safety for the driver. A coefficient of static friction of 0.25 is an appropriate upper limit value for an appropriate static friction.

It is particularly advantageous that, by using a plain bearing, the whole arrangement, particularly the hub body, is smaller and consequently weight can be reduced. This is particularly advantageous for mountain bikes or for BMX bicycles.

Particularly preferably, an axial bearing is provided on either side of the bottom bracket, particularly preferably in an arrangement, wherein for each side of the bottom bracket a radial bearing in form of a plain bearing bush is also provided, which are distanced from each other.

The axial bearing is particularly preferred to be a rolling element bearing, such as particularly a ball bearing. As in the axial direction a certain backlash is desirable, a plant should possibly have no influence on the relative rotatability of the parts towards each other, so that for strains in the axial direction friction forces as small as possible are desirable. On the other hand, angular positions of the pedal crankshaft are to be maintained as possible, i.e. the pedal crank arm and thus the pedals must not change position easily, in order to prevent the pedal position from changing when the pedals are released for a short time, as it frequently occurs, for example, in tricks with BMX bicycles.

Alternatively, the axial bearing can also be a plain bearing, according to the radial bearing. However, in this case the friction is less than that of the radial bearing in every working condition, i.e. the axial bearing friction forces have a smaller influence than the radial bearing friction forces.

An equivalent structure is also possible in case of a bicycle hub. In this case, the forces which are acting on the hub body or are to be conducted into it, are absorbed and forwarded by the two bearings. The radial forces are absorbed by the plain bearing bush, whereas the axially effective forces are absorbed by the side bearing, preferably exclusively each time. The plain bearing bush is cheaper than a conventional ball bearing. As the plain bearing bush is a “friction bearing”, friction occurs. This friction, for example, makes it easier to perform tricks with a BMX freestyle bicycle. The side bearing prevents that the lock nut jams the hub body and/or the plain bearing bush, so that the friction-afflicted rotation of the hub body relative to the axle would additionally be obstructed, thus the hub body would be too stiff. Furthermore, the assembly of the hub is less sensitive to how tightly the lock nut is fastened, because the contact surface of the side bearing is far greater than the frontal surface of the plain bearing bush.

In the following, the invention is explained more in detail on the basis of several embodiments represented in the drawing. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a partially sectional view of the first hub;

FIG. 2 is a partially sectional view of the second hub

FIG. 3 is a view showing the components for the hub body being entrained by the pinion;

FIG. 4 is a side view a bicycle according to the invention;

FIG. 5 is a partially sectional bottom view of the bottom bracket portion;

FIG. 6a is a side view of the bottom bracket of FIG. 5;

FIG. 6b is a cross-sectional view of the bottom bracket of FIG. 5;

FIG. 6c is a partially sectional view of the bottom bracket of FIG. 5 according to an alternative embodiment in view of the shape of the plain bearing bush; and

FIG. 7 a partially sectional view according to FIG. 5 with a bottom bracket according to an alternative embodiment.

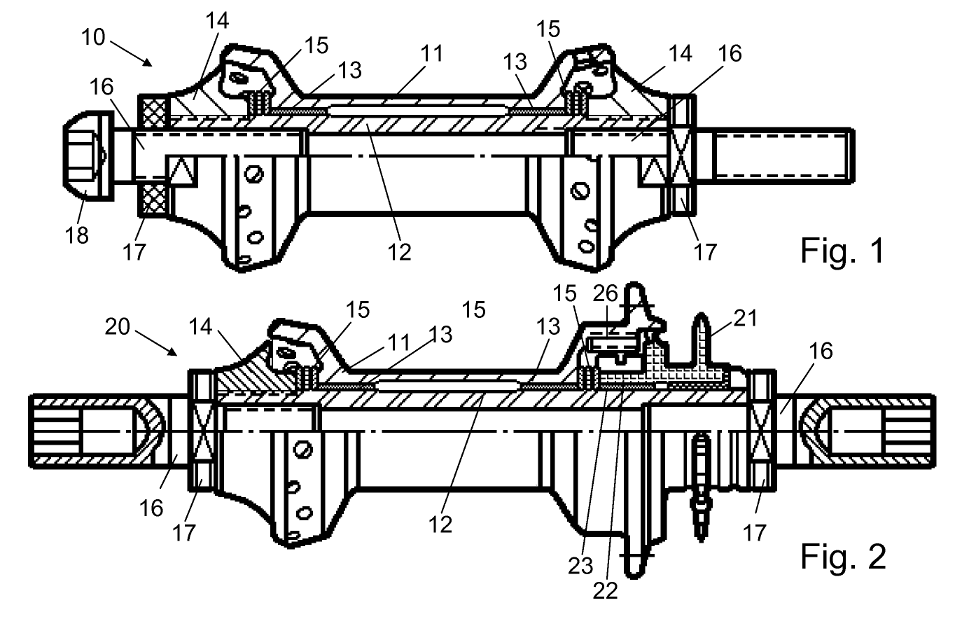

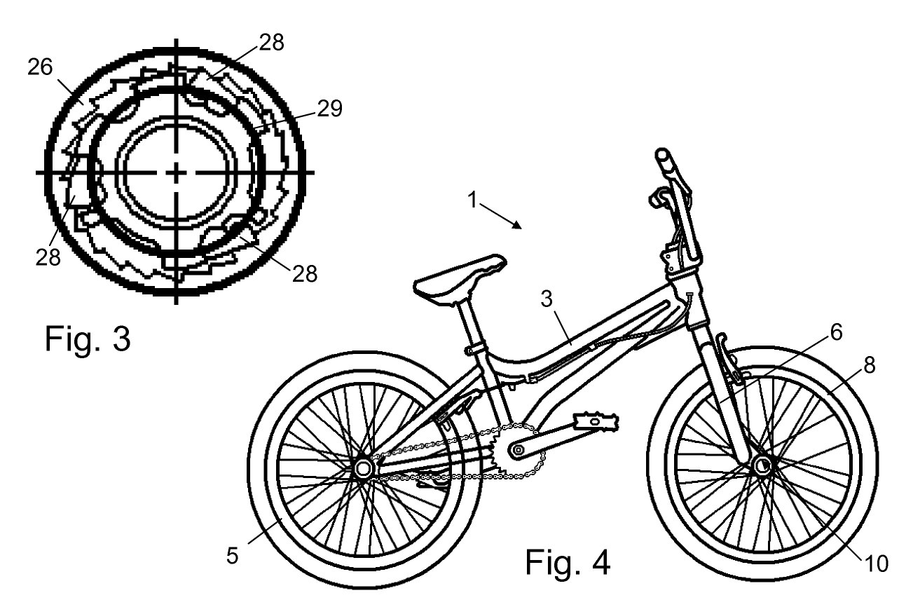

### DESCRIPTION OF THE PREFERRED EMBODIMENTS

Referring to the drawings in particular, A bicycle 1 presents a frame 3 that has, at its rear end, the back wheel 5 of the bicycle 1 and, at its front end by means of a fork 6, the front wheel 8 of the bicycle 1.

The front wheel 8 presents, in its center, a first hub 10. The first hub 10 comprises a hub body 11 and an axle 12 with a center axis, which defines a cylindrical coordinate system. The axle 12 is arranged radially inside the hollow hub body 11, and is mounted rotatably (in circumferential direction) in the hub body 11 by means of at least one, here two plain bearing bushes 13, which are axially distant from each other. Both the hub body 11 and the axle 12 can consist of aluminum. The plain bearing bushes 13 are arranged radially between the hub body 11 and the axle 12 and in the present case pressed into the existing hub body 11. The plain bearing bushes 13 are in direct sliding contact with axle 12 and thus generate friction, i.e. they are not frictionless or low-friction bearings, like for example a ball bearing. For setting the friction, a fixed coating of the plain bearing bushes 13 can be provided, whereas a lubricant film is not desired.

At both axial ends, the hub body 11, in each case, presents a flanged area provided with holes, in which the spokes are suspended. To the axle 12, a respective lock nut 14 is screwed axially on both sides, which secures the hub body 11 in the axial direction. The lock nut 14 is screwed against a side bearing 15 at its end that is axially pointing to the inside, which in turn adheres in the axial direction to the hub body 11 and to the assigned plain bearing bush 13. The side bearings 15 are, in this case, formed as plate bearings and substantially consist of two parallel washers with rolling elements (e.g. balls or rollers) in-between, and are thus based on rolling friction of the rolling elements. Basically, other bearing types than side bearings would also be usable, as far as they absorb the axially acting forces. In a way well-known in principle, a grub screw 16, for example in steel, is axially screwed on both sides into the hollow axle 12, on which a bearing washer 17 is positioned against the lock nut 14, and which, for its part, is introduced into an appropriate seat of the fork 6 and is secured by means of a nut 18.

The hub body 11 is thus mounted in the radial direction by means of the plain bearing bushes 13 (which absorb all the radially acting forces) and in axial (thus lateral) direction by means of the side bearings 15 (which absorb all the axially acting forces). Due to the side bearings 15, it is avoided that the locknuts 14 axially directly touch the plain bearing bushes 13 and in this way obstruct the rotation of the hub body 11. The arrangement is not sensitive to the tightening of the locknuts 14.

The back wheel 5 presents, in its center, a second hub 20, which resembles the first hub to a great extent, for which reason parts that are equal and parts that seem similar have the same reference signs. The axle 12 defines a corresponding cylindrical coordinate system. The second hub 20 especially corresponds to the first hub 11 on the left hand side opposite to pinion 21. On the pinion 2, a collar 22 axially pointing to the inside (on the left) is formed, while the pinion 21 and its collar 22 are mounted rotatably on the axle 12 with, in-between, at least one further plain bearing bush 23. The collar 22 strikes the side bearings 15 situated there (on the right hand side) with its end pointing to the inside (to the left). Here, the side bearing 15 also prevents a direct adhesion of the collar 22 to the neighboring plain bearing bush 13 of the hub body 11.

For the hub body 11 being entrained by the pinion 21, a driving ring 26 is fixed to the hub body 11, for example a hardened ring. The driving ring 26 has a sawtooth form at the inside, with which carrier clutches 28 cooperate, which are mounted movably on the collar 22 and are prestressed by a spring 29. In the fashion of a ratchet, the hub body 12 is entrained in only one rotational direction of the pinion 21, in the drawing counter-clockwise, whereas in the opposite rotational direction a free run is realized.

The fixing of the second hub 20 by means of grub screws 16 on both sides, bearing washers 17 and nuts 18 corresponds to that of the first hub 10. The hub body 11 is thus also mounted in radial direction by means of the pedal position of the plain bearing bushes 13 (which absorb all the radially acting forces) and axial direction (thus lateral) by means of the side bearings 15 (which absorb all the axially acting forces).

The bicycle 1 has said frame 3 that supports the rear wheel 5 at the rear of bicycle 1 and, by means of the fork 6 at the front of bicycle 1, the frame 3 supports the front wheel 8 of the bicycle 1. The frame 3 is of a diamond-like form comprising or consisting of a main “triangle” having a top tube, a seat tube, a down tube and a short head tube, and two rear “triangles”, each having a seat stay (e.g., tube), a chain stay (e.g., tube), and the seat tube as a common part of all rear “triangles”.

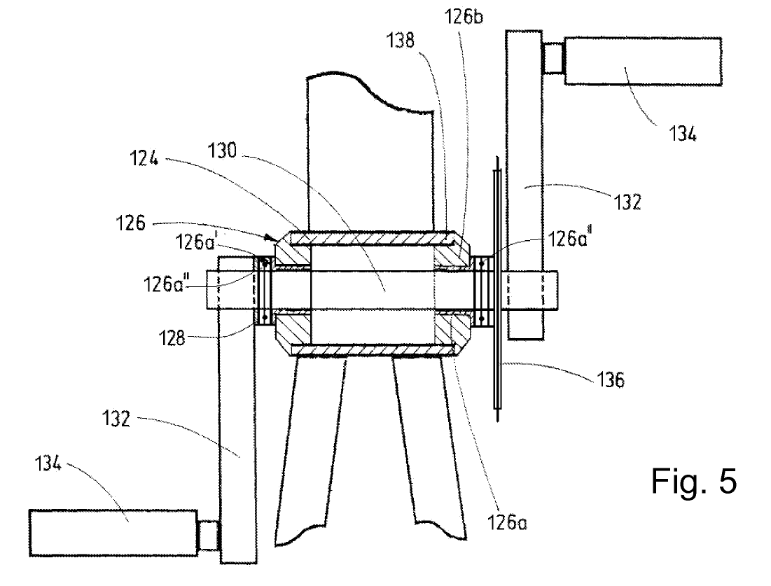

A bottom bracket shell 124 is provided where the down tube, the seat tube, and the two chain stays are connected (e.g., the down tube, seat tube, and chain stays are mounted (e.g., welded) to the bottom bracket shell 124). The bottom bracket portion is shown in FIG. 5. The bottom bracket shell 124 is a short tube running side to side, a direction which is called “axial” hereinafter. With respect to the axial direction of the bottom bracket shell 124, the seat tube, the down tube, and the chain stays project from the bottom bracket shell 124 in a direction which is called “radial” hereinafter.

The bottom bracket shell 124 holds a bottom bracket 126, and the bottom bracket 126 bears a crank shaft 130, which is arranged in the axial direction. A crank arm 132 is mounted on each of the two ends of the crank shaft 130, and each crank arm 132 bears a pedal 134 in a conventional manner. On one side of the bottom bracket shell 124, a front gear 136 is mounted on the crank shaft 130. The front gear 136 is typically mounted for rotating with the crank shaft 130 in a conventional manner, with the front gear 136 typically being linked, in a conventional manner, to the rear wheel 5 via a chain and rear gear.

According to the exemplary embodiment of the invention, the bottom bracket 126 comprises two bush bearings 126a (e.g., bushings that are used as bearings), with the bush bearings 126a being arranged in the axial direction and fixed to the bottom bracket shell 124. According to the exemplary embodiment of the invention, the bush bearings 126a are not antifriction bearings (e.g., the bush bearings 126a are not ball bearings). More specifically according to the exemplary embodiment of the invention, the inner diameter of the bush bearings 126a corresponds to (e.g., is substantially the same as, such as by being slightly larger than) the outer diameter of the crank shaft 130, so that the bush bearings 126a are configured as “friction bearings” (e.g., there is typically direct, sliding contact between the inwardly facing inner surfaces of the bush bearings 126a and the corresponding outwardly facing outer surfaces of the crank shaft 130, and any provision of fluid lubricant (for reducing the friction associated with the direct, sliding contact) typically does not result in a film of lubricant that is thick enough to avoid direct, sliding contact between the inwardly facing inner surfaces of the bush bearings 126a and the corresponding outwardly facing outer surfaces of the crank shaft 130 (e.g., the bush bearings 126a are not fluid bearings)).

The radial size of the bottom bracket shell 124 offers different realizations of (e.g., designs of) the bottom bracket 126. As mentioned above for the exemplary embodiment of the present invention, the inner diameter of the bush bearings 126a corresponds to the outer diameter of the crank shaft 130. Depending on the inner diameter of the bottom bracket shell 124 (compared to the outer diameter of the bush bearings 126a), the bush bearings 126a may be fixed to the bottom bracket shell 124 directly or via an adapter, called cap 126b. Such a cap 126b is preferably made of an aluminum alloy and has preferably an annular shape. Throughout this disclosure, “preferably” should be understood to at least mean “optionally”.

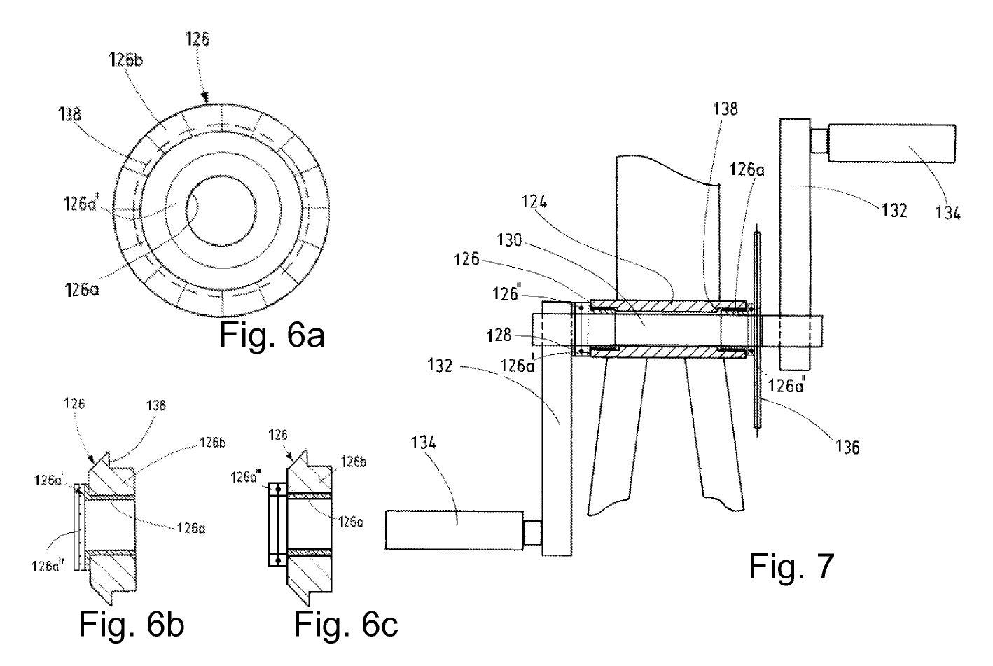

The plain bearing bushes 126a in this case comprise a flanged area 126a′ projecting outwards, which projects over the frontal surface of the caps 126b which house the plain bearing bushes 126a, as visible in FIG. 6b. Alternatively, the plain bearing bushes 126a can, for example, also be flush with the caps 126b, as shown in FIG. 6c.

The cap 126b is preferably provided with a step 138 (e.g., an annular shoulder), defining a covering part which is covering (e.g., at least partially covering) the front side (e.g., end face) of the bottom bracket shell 124, and a projecting part (e.g., an annular projection) which is pressed in (e.g., press-fit in) the bottom bracket shell 124. Alternatively, the bush bearings 126a may be fixed directly to the bottom bracket shell 124, in which case the bottom bracket shell 124 is preferably provided with a step 138 (e.g., shoulder) on each side, defining a receptacle for the bush bearing 126a, with the bush bearing 126a being pressed into (e.g., press-fit in) the bottom bracket shell 124.

In addition to the plain bearing bushes 126a acting exclusively in the radial direction of the bottom bracket area, ball bearings 126a″ acting exclusively in the axial direction are provided, which in this case adhere to the frontal surface of the flanged area 126a′ of the plain bearing bush 126a. The ball bearings 126a″ are each arranged externally, i.e. on the pedal crank arm side. The friction of the ball bearings 126a″ is in this case less than that of the plain bearings, wherein in an orderly assembly of the bicycle the rolling friction compared to the sliding friction can substantially be neglected, i.e. the total friction of the pedal crankshaft substantially corresponds to the sliding friction of the plain bearing bushes 126a. In particular, the axial clamping of the components arranged on the pedal crankshaft hardly has an influence on the friction forces which counteract a turning of the pedals, particularly on the static friction at rest.

The outer frontal surfaces of the ball bearings 126a″ each adhere to a sleeve 128. The sleeve 128 represented in FIG. 5 on the left extends coaxially to the pedal crankshaft 130 between the left frontal surface of the left ball bearing 126a″ and the pedal crank arm 132, the sleeve 128 being in this case is fixed to the pedal crankshaft. The sleeve 128 represented in FIG. 5 on the right extends coaxially to the pedal crankshaft 130 between the right frontal surface of the right ball bearing 126a″ and the chain ring 136. Alternatively, the sleeve between the chain ring and the ball bearing and/or the pedal crank arm and the ball bearing can also be omitted.

FIG. 6c shows a variant, in which, instead of a plain bearing with a flanged area, a plain bearing 126a in the form of a bushing without a flanged area is provided as a radial bearing. Also in this case, a ball bearing 126a″ is provided again as an axial bearing, which is arranged in connection to the plain bearing bush 126a and the frontal surface of the cap 126b.

In accordance with an alternative embodiment of the present invention, shown in FIG. 7, the bush bearings 126a are pressed on (e.g., fixedly connected to) the crank shaft 130, with the bush bearings 126a being borne (e.g., pivotably borne) within the receptacle of the bottom bracket shell 124. In accordance with this alternative embodiment, the bush bearings 126a are configured as “friction bearings”, for operating by means of direct, sliding contact. The axial mounting occurs via the ball bearings 126a″, which in turn adhere to flanged areas, which project radially outwards, of the plain bearing bushes 126a, which form the contact surface to the bottom bracket shell 124 at their front sides facing the middle plane of the bicycle. The sleeves 128 can, for example, be omitted on one side, as shown on the right hand side of FIG. 7.

According to the above-described exemplary embodiments, the plain bearings, if paired with steel without lubrication, show a coefficient of static friction of 0.2, while the lateral bearings (plain bearing bushes) have an equivalent coefficient of static friction (at the moment when the movement of the roller bodies starts) of approx. 0.02, i.e. they differ by a factor in the order of ten.

While the equivalent coefficients of static friction for the plain bearing bushes are within a range of 0.01 and 0.05, the coefficients of static friction of the plain bearings preferably are considerably higher, particularly at a minimum of 0.08, particularly preferably a minimum of 0.1. The upper limit value preferably is 0.25.

While specific embodiments of the invention have been described in detail to illustrate the application of the principles of the invention, it will be understood that the invention may be embodied otherwise without departing from such principles.

What is claimed is:

1. A bicycle comprising:
a bicycle hub with an axle which defines an axial direction;
a hollow hub body mounted rotatably on said axle;
at least one lock nut which secures the hub body in the axial direction;
at least one plain bearing bush provided to absorb radial acting forces, said at least one plain bearing bush being arranged radially between said hub body and said axle, said hub body being mounted via said at least one plain bearing bush with sliding contact on the axle; and
at least one side bearing provided to absorb axially acting forces, said at least one side bearing being arranged axially between said at least one the lock nut and said at least one plain bearing bush and/or said hub body said at least one side bearing for mounting said hub body laterally.

2. A bicycle according to claim 1, wherein the plain bearing bush only absorbs radially acting forces and the side bearing is formed by a rolling-element bearing and only absorbs axially acting forces.

3. A bicycle according to claim 1, further comprising another side bearing wherein said at least one side bearing is provided at one side of said hub body and said another side bearing is provided at another side of said hub body.

4. A bicycle according to claim 3, wherein in each of said at least one side bearing and said another side bearing a plain bearing bush is provided.

5. A bicycle according to claim 1, wherein each of said plain bearing bush and said hub body abut said side bearing in the axial direction.

6. A bicycle comprising:
a frame which comprises a bottom bracket shell;
a bottom bracket spindle with pedal crank arms carrying pedals;
a bottom bracket, said bottom bracket spindle being mounted by means of said bottom bracket in said bottom bracket shell;
a pedal bearing comprising at least one plain bearing bush to absorb radially acting forces, said at least one plain bearing bush being arranged and mounted radially between said bottom bracket spindle and said bottom bracket shell and at least one axial bearing to absorb axially acting forces, said at least one axial bearing being mounted axially at an outside of said bottom bracket and leaning on a tread.

7. A bicycle according to claim 6, wherein said plain bearing bush only absorbs radially effective forces and said axial bearing is formed as a rolling element bearing and only absorbs axially effective forces.

8. A bicycle according to claim 6, further comprising another axial bearing wherein on each side of said bottom bracket an axial bearing is provided.

9. A bicycle according to claim 6, further comprising another plain bearing bush wherein the at least one plain bearing bush is provided at one side for the radial mounting and said another plain bearing bush is provided at another side for the radial mounting.

10. A bicycle according to claim 6, wherein the plain bearing has a coefficient of static friction that is a minimum of 0.08.

11. A bicycle according to claim 6, wherein the plain bearing has a coefficient of static friction that is a minimum of 0.1.

12. A bicycle comprising:
a frame which comprises a bottom bracket shell;
a bottom bracket spindle with pedal crank arms carrying pedals;
a bottom bracket, said bottom bracket spindle being mounted by means of said bottom bracket in said bottom bracket shell;
a pedal bearing;
a bicycle hub with an axle which defines an axial direction;
a hollow hub body mounted rotatably on said axle;
at least one lock nut which secures the hub body in the axial direction; and
a hub bearing arrangement, at least one of said pedal bearing and said hub bearing arrangement including a plain bearing bush provided to absorb radial acting forces and a bearing provided to absorb axially acting forces.

13. A bicycle according to claim 12, wherein said plain bearing bush provided to absorb radial acting forces has a minimum coefficient of static friction of from 0.08

14. A bicycle according to claim 12, wherein said plain bearing bush provided to absorb radial acting forces has a coefficient of static friction of from 0.08 to 0.25.

15. A bicycle according to claim 12, wherein said plain bearing bush provided to absorb radial acting forces is arranged radially between said hub body and said axle, said hub body being mounted via said at least one plain bearing bush with sliding contact on the axle and said hub bearing arrangement includes at least one side bearing provided to absorb axially acting forces, said at least one side bearing being arranged axially between said at least one the lock nut and said at least one plain bearing bush and/or said hub body said at least one side bearing for mounting said hub body laterally.

16. A bicycle according to claim 15, wherein said plain bearing bush only absorbs radially effective forces and said side bearing is an axial bearing formed as a rolling element bearing and only absorbs axially effective forces.

17. A bicycle according to claim 16, further comprising
another axial bearing wherein on each side of said bottom bracket one of the axial bearings is provided
another plain bearing bush wherein the at least one plain bearing bush is provided at one side for the radial mounting and said another plain bearing bush is provided at another side for the radial mounting.

18. A bicycle according to claim 12, wherein said plain bearing bush is arranged and mounted radially between said bottom bracket spindle and said bottom bracket shell and said pedal bearing includes at least one axial bearing to absorb axially acting forces, said at least one axial bearing being mounted axially at an outside of said bottom bracket and bearing on a tread.

19. A bicycle according to claim 17, wherein said plain bearing bush only absorbs radially effective forces and said axial bearing is formed as a rolling element bearing and only absorbs axially effective forces.

20. A bicycle according to claim 19, further comprising:
another axial bearing wherein on each side of said bottom bracket an axial bearing is provided; and
another plain bearing bush wherein the at least one plain bearing bush is provided at one side for the radial mounting and said another plain bearing bush is provided at another side for the radial mounting.
